(19) United States
(12) Patent Application Publication
(10) Pub. No.: US 2014/0223048 A1
(43) Pub. Date: Aug. 7, 2014

(54) COMMUNICATION NETWORK AND METHOD FOR COMMUNICATING IN A COMMUNICATION NETWORK

(71) Applicant: INFINEON TECHNOLOGIES AG, Neubiberg (DE)

(72) Inventor: Wolfgang Troeger, Muenchen (DE)

(73) Assignee: INFINEON TECHNOLOGIES AG, Neubiberg (DE)

(21) Appl. No.: 13/760,179

(22) Filed: Feb. 6, 2013

(51) Int. Cl. G06F 13/42

(52) U.S. Cl. CPC G06F 13/4286
USPC 710/106

(57) ABSTRACT

A communication network is described comprising a first bus interface, a second bus interface, a bus which connects the first bus interface and the second bus interface, one or more receivers connected to the bus, a detector configured to detect whether a first message transmitted via the bus by the first bus interface has reached the one or more receivers; and a controller configured to, if the first message has not reached the one or more receivers, control the second bus interface to transmit at least one second message to at least one of the one or more receivers via the bus.

### TECHNICAL FIELD

The present disclosure relates to communication networks and methods for communicating in a communication network.

### BACKGROUND

For vehicle manufacturers it is desirable that slave modules of a vehicle bus system for a certain application (e.g. for controlling air conditioning flaps or for lighting components) can be treated as identical modules to reduce the effort in storage and supply. For this, auto-addressing methods have been development such that slave modules do not need to be distinguished because of address. However, auto-addressing methods may require an architecture that increases the susceptibility to a disconnection of one or more slaves modules from a central controller. It is desirable to avoid such disconnections in context of auto-addressing or operation of a bus system.

### SUMMARY

According to one embodiment, a communication network is provided a first bus interface, a second bus interface, a bus which connects the first bus interface and the second bus interface, one or more receivers connected to the bus, a detector configured to detect whether a first message transmitted via the bus by the first bus interface has reached the one or more receivers; and a controller configured to, if the first message has not reached the one or more receivers, control the second bus interface to transmit at least one second message to at least one of the one or more receivers via the bus.

According to another embodiment, a method for communicating in a communication network according to the communication network described above is provided.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows a communication network.

FIG. 2 shows a communication network.

FIG. 3 shows a slave module.

FIG. 4 shows a communication network.

FIG. 5 shows a flow diagram.

FIG. 6 shows a communication network.

FIG. 7 shows LIN transceiver module.

### DESCRIPTION

The following detailed description refers to the accompanying drawings that show, by way of illustration, specific details and aspects of this disclosure in which the invention may be practiced. These aspects of this disclosure are described in sufficient detail to enable those skilled in the art to practice the invention. Other aspects of this disclosure may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

In modern vehicles, various bus systems may be used. For example, these are CAN (Controller Area Network), Flexray and the LIN (Local Interconnect Network), also referred to LIN bus.

The LIN is a serial communication system which was developed for the communication of intelligent sensors and actors in vehicles at low cost is based on a single wire bus and may be classified as a field bus. A typical application scenario is the networking within a vehicle door, of a seat, of air conditioning flaps or the various light sources of an interior lighting system.

LIN is typically applied where the higher bandwidth and the higher versatility of CAN is not required. The LIN specification includes the LIN protocol, a unified format for the description of the overall LIN and the interface between a LIN and the respective application.

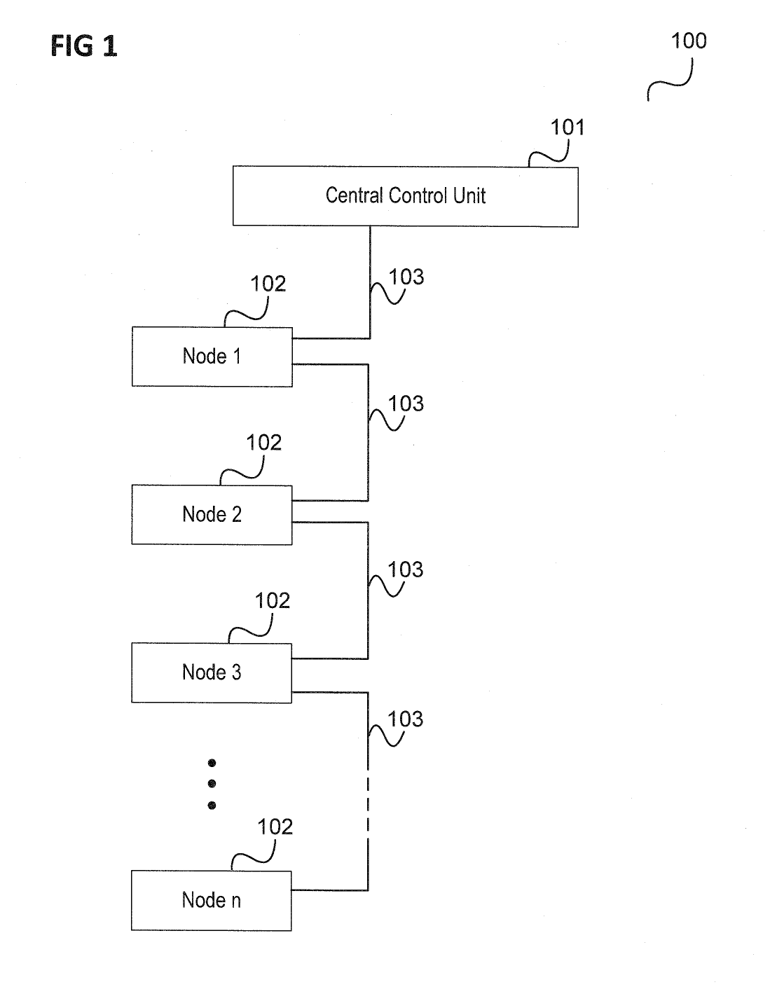

A LIN is illustrated in FIG. 1.

FIG. 1 shows a communication network 100.

The communication network 100 is in this example a Local Interconnect Network (LIN).

A LIN is composed of a bus master, in this example formed by a central control unit 101, e.g. a central controller in a vehicle, such as for controlling the lighting and/or the air conditioning in the vehicle, such as a HVAC (Heating, Ventilation and Air conditioning) controller or a BCM (Body Control Module) of a vehicle, and one or more slaves, in this example a plurality of nodes 102. Each node for example includes a controller and an LED (light emitting diode) or a controller and an air conditioning flap. The central controller 101 and the nodes 102 are connected in series by a bus 103.

The central controller 101 has (as bus master) knowledge about the scheduling of the transmission between the central controller 101 and the nodes (slaves) 102. A node 102 transmits data upon when the central controller 101 has requested it to do that. The central controller 101 does this by sending a header which is marked with a certain address. In response, the node 102 supplies the data to be transmitted to the bus 103. Each node 102 has a unique address via which it may be addressed by the central controller 101.

The modules (i.e. the central controller 101 and the nodes 102) each include a LIN transceiver which translates data to be sent (e.g. from a microcontroller of the module) into 12 V signals which are transmitted via the LIN bus 103 to another module. In case of an application within a vehicle door or a seat these may be different nodes (slaves) 102 which communicate via the LIN bus.

In contrast, in case of air conditioning or (interior) lighting the slaves 102 are typically identical. For example, the communication network 100 may include a plurality of identical slaves 102 each controlling an air conditioning flap and each including its own (micro) controller, a power supply and a LIN transceiver. In case of interior lighting, the communication network 100 for example includes a plurality of identical slaves 102 wherein each slave 102 includes a printed circuit board with an LED, a power supply, a micro controller and LIN transceiver. In both applications, air condition and lighting, a multiplicity of such identical modules may be used, e.g. more than 30.

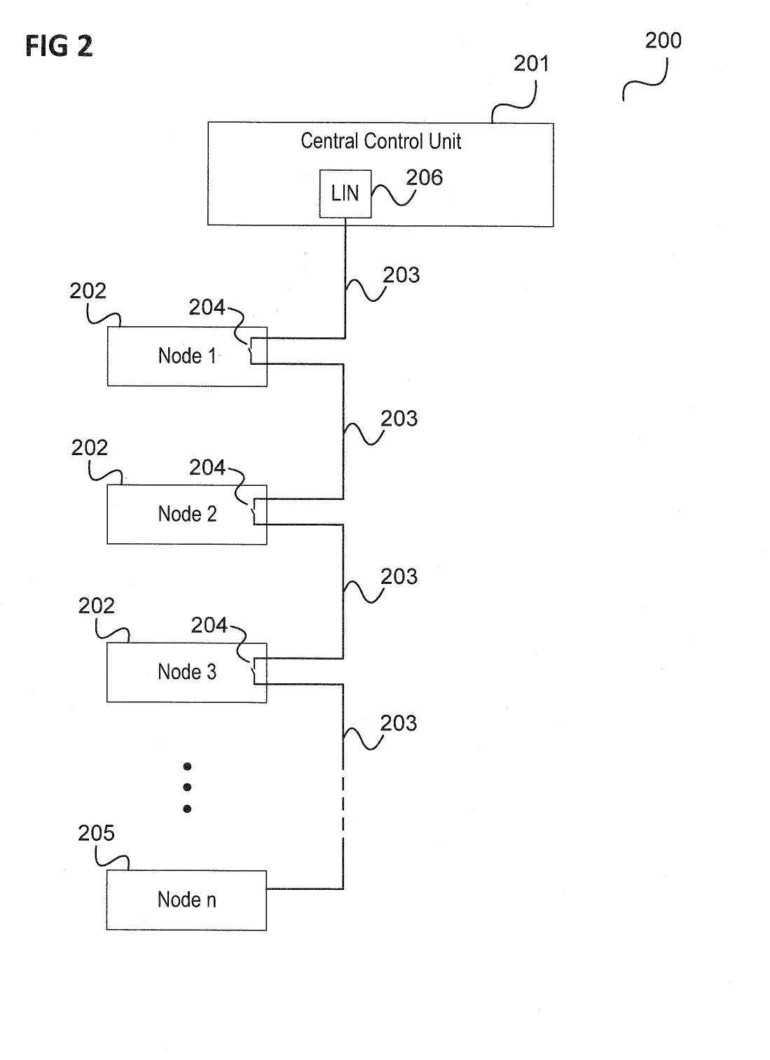

In the communication network 100, the identical modules may be distinguished based on their address. However, it is desirable for the vehicle manufacturer that the modules can be treated as being identical in stock instead of, e.g. treating 30 or more slave modules as different modules. For this, the concept of auto addressing the slave modules was developed. In this concept, a slave module does not have a fixed address but an address is assigned to it in a starting cycle (e.g. upon startup of the vehicle or once in an initial configuration phase after the vehicle has been manufactured after which the address is stored in a memory of the slave module). Auto-addressing of slave modules may be done using the Bus Shunt Method (BSM) or the Extra Wire Daisy Chain (XWDC) method. A further approach is a concept called bus switch. The corresponding bus structure is shown in FIG. 2.

FIG. 2 shows a communication network 200.

Similarly to the communication network 100, the communication network 200 includes a central controller 201 and a plurality of nodes 202, 206 connected by a bus 203. In FIG. 2, a LIN transceiver 206 of the central controller 201 is further shown which may transmit data to the nodes 202 and receive data from the nodes 202 via the bus 203. The LIN transceiver 206 acts as bus master (or, in other words, the central controller 201 acts as bus master by means of the LIN transceiver 206).

According to the bus switch auto-addressing approach, the bus 203 may be interrupted at each intermediate node 202, i.e. each node 202 except the last node in line 205, i.e. in the series of nodes 202), by a switch 205 of the respective node 202.

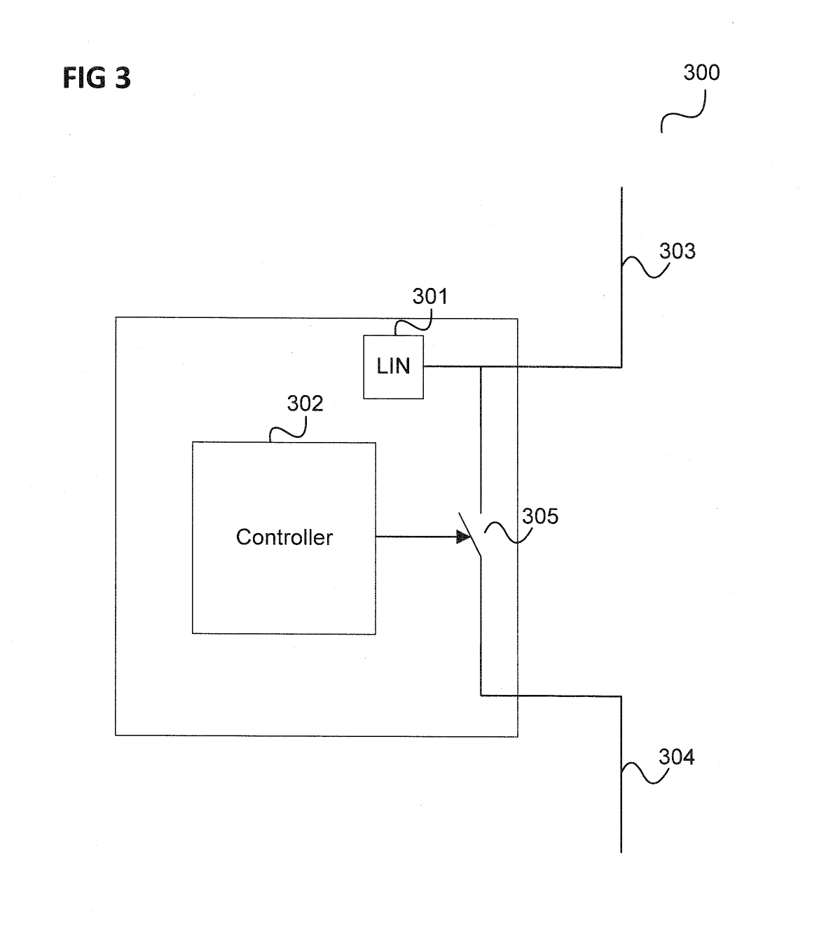

The structure of the intermediate node 202 is shown in more detail in FIG. 3.

FIG. 3 shows a slave module 300.

The slave module 300 includes a LIN transceiver 301 and a microcontroller 302 which serves, depending on the application, for example for controlling an LED or an air conditioning flap. The LIN transceiver 301 has a bus connection 303 to the preceding node 202 in the series of nodes 202 and a bus connection 304 via a switch 305 to the subsequent node 202, 205 in the series of nodes 202. The microcontroller 302 operates the switch 304, e.g. closes it once an address had been assigned to the slave module 300.

At the beginning of the auto-addressing procedure according to the bus switch auto-addressing method the switches 204 of all intermediate nodes 202 are open and no addresses are yet assigned to the nodes 202. The auto-addressing procedure begins with the central controller 201 contacting the first node 202 in the series of nodes 202, 205 and assigns an address to that node 202. After that, the first node 202 closes its switch 204 such that the central controller 201 can now contact the second node 202 in the series of nodes 202, 205 to assign and address to that node 202 and so on until an address is assigned to all nodes 202, 205.

In this structure, however, there is the risk that the switch 204 of one of the intermediate node modules 202 or its control logic fails, i.e. does not close after the node module 202 was supplied with an address or opens after a while, and the subsequent node modules of the series of node modules 202, 205 get isolated from the central controller 201, i.e. fail. The bus may also be interrupted at any other point resulting in some or all of the node modules 202 being isolated from the central controller 201.

According to one embodiment, this issue is addressed by connecting the bus 203 at its endpoint (i.e. at the last node 205 in line) back to the central controller 201, e.g. to a second LIN transceiver (e.g. referred to as failure LIN transceiver) of the central controller 101 which may be operated as a master as well as a slave for the bus 203.

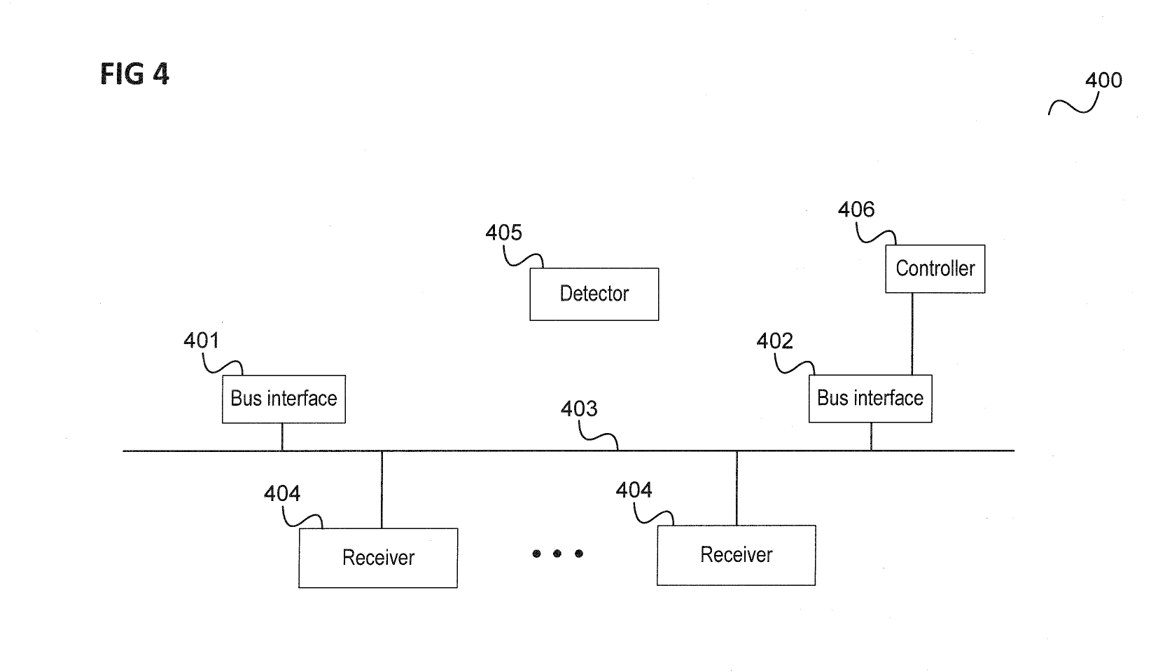

An embodiment is described in the following with reference in FIG. 4.

FIG. 4 shows a communication network 400.

The communication network 400 includes a first bus interface, a second bus interface and a bus which connects the first bus interface and the second bus interface.

The communication network 400 further includes one or more receivers connected to the bus and a detector configured to detect whether a first message transmitted via the bus by the first bus interface has reached the one or more receivers.

Further, the communication network 400 includes a controller configured to, if the first message has not reached the one or more receivers, control the second bus interface to transmit at least one second message (e.g. in opposite direction than the first message) to at least one of the one or more receivers via the bus.

According to one embodiment, in other words, a first bus interface and a second bus interface, e.g. of the same central controller, are provided for a bus, wherein the second bus interface becomes active, e.g. sends a message to one or more receivers (e.g. slaves) connected to the bus when it is detected that a message sent by the first bus interface has not arrived (e.g. due to an interruption of the bus, e.g. due to a fail of a switch of one of the slaves) at the one or more receivers.

The first message may be addressed to at least one of the one or more receivers (e.g. to the same at least one of the one or more receivers as to which the second message is addressed) but it may also be a test message for testing whether the bus is interrupted, e.g. addressed to the second bus interface.

The bus may be a LIN bus for connecting components in a vehicle as in the examples above and below but may also be another bus applied in a different scenario, e.g. a non-automotive bus for connecting various systems in a house (e.g. lighting, roller shutters, heating etc.)

The one or more receivers are for example connected to the bus at one or more connection points of the bus that lie between the connection points of the first bus interface and the second bus interface to the bus. In other words, the receivers are nodes that are arranged between the first bus interface and the second bus interface.

The detector is for example configured to detect whether the first message has reached the one or more receivers by detecting whether the first message has been received by the second bus interface

According to one embodiment, the detector is configured to detect whether the first message has reached the one or more receivers by detecting whether the one or more receivers have received the first message.

The detector is for example configured to detect whether the first message has reached the one or more receivers by detecting whether the one or more receivers have acknowledged reception of the first message.

For example, the detector is configured to detect whether the one or more receivers have acknowledged reception of the first message by counting the number of acknowledgements of reception of the first message and comparing the number with the number of receivers.

The one or more receivers are for example connected to the bus at one or more connection points of the bus that lie between the connection points of the first bus interface and the second bus interface to the bus.

The communication network may further comprise a first transceiver coupled the first bus interface configured to supply the first message to the first bus interface.

For example, the first transceiver is coupled to the detector and is configured to inform the detector about the transmission of the first message.

The first transceiver is for example configured to provide the second message and is for example coupled to the second bus interface by means of a switch and the controller is for example configured to control the switch such that the second message is supplied to the second bus interface if the first message has not reached the one or more receivers. The first transceiver for example sends the first message over both the first bus interface and the second bus interface.

The first transceiver for example acts as a master of the bus.

According to one embodiment, the communication network further comprises a second transceiver coupled to the second bus interface wherein the controller is configured to, if the first message has not reached the one or more receivers, control the second bus interface to transmit the at least one second message to at least one of the one or more receivers via the bus by controlling the second receiver to supply the second message to the second bus interface.

The at least one of the one or more receivers may be understood as a receiver different from the first transceiver and the second transceiver, e.g. arranged between the first transceiver and the second transceiver on the bus. The one or more receivers are for example bus slaves while the first transceiver is for example a bus master.

According to one embodiment, the communication network further comprises a second transceiver coupled with the second bus interface wherein the second transceiver is coupled to the detector and is configured to inform the detector about the reception of the first message and wherein the detector is configured to detect whether the first message has reached the one or more receivers by detecting whether the second transceiver has received the first message.

For example, the controller is configured to, if the second transceiver has not received the first message, switch the second transceiver from a slave mode in which it acts as a slave of the bus to a master mode in which it acts as a master of the bus.

For example, the second transceiver, when in master mode, is configured to control bus usage by the one or more receivers.

The first message is for example addressed to the at least one of the one or more receivers.

The second message is for example addressed to the at least one of the one or more receivers.

The second message is for exmaple an inquiry message.

According to one embodiment, the first message is a test message for testing whether the second bus interface can be reached by the first bus interface via the bus, e.g. addressed to the second bus interface or the second transceiver.

The second message is for example an address allocation message for assigning an address to the at least one of the one or more receivers.

The second message may be a communication control message for controlling usage of the bus by the at least one of the one or more receivers.

According to one embodiment, the second message is a data request message requesting data from the at least one of the one or more receivers.

The bus is for example a Local Interconnect Network bus.

The one or more receivers for example act as slaves of the bus.

According to one embodiment, the communication network further comprises a control device (e.g. comprising the first transceiver and/or the second transceiver) configured to supply the first message to the first bus interface and, if the first message has not reached the one or more receivers to supply the second message to the second bus interface.

The control device is for example a central controller of a vehicle and the one or more receivers are control devices configured to control vehicle components.

The communication network may further comprise at least one switch for interrupting the bus.

For example, the communication network comprises a plurality of receivers, wherein the at least one switch is arranged to interrupt the bus between two receivers of the plurality of receivers.

The first bus interface and the second bus interface for example form the endpoints of the bus.

The components of the communication network (e.g. the bus interfaces, the transceivers, the receivers, the detector, the controller, etc.) may for example be implemented by one or more circuits. A “circuit” may be understood as any kind of a logic implementing entity, which may be special purpose circuitry or a processor executing software stored in a memory, firmware, or any combination thereof. Thus a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit”.

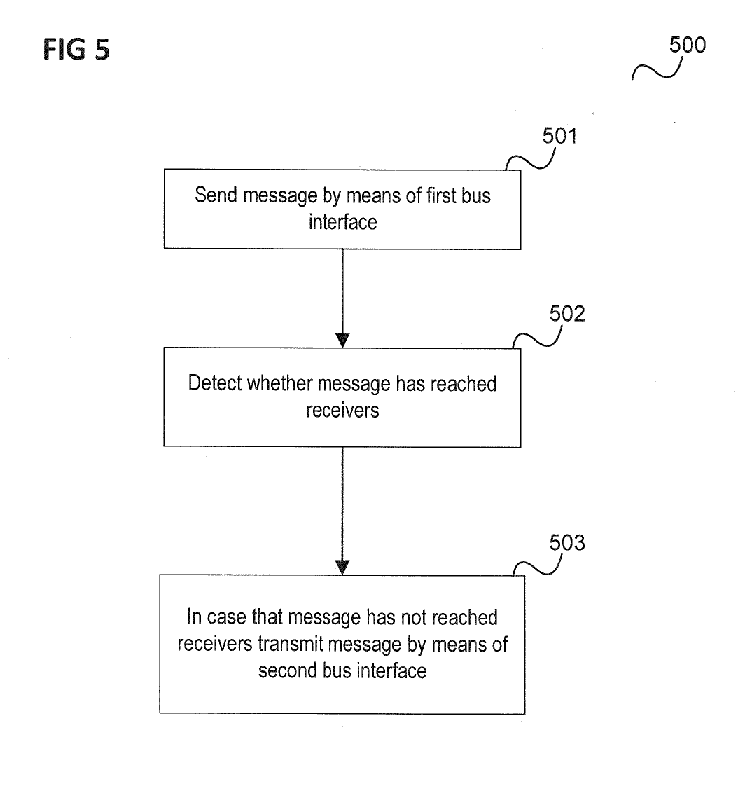

The computer network 400 for example carries out a method as illustrated in FIG. 5.

FIG. 5 shows a flow diagram 500.

The flow diagram illustrates a method for communicating in a communication network, e.g. a bus system.

In 501, a first message is transmitted via a bus connecting a first bus interface and a second bus interface by means of the first bus interface.

In 502 it is detected whether the first message has been received by one or more receivers connected to the bus.

In 503, if the first message has not reached the one or more receivers, a second message is transmitted via the bus to at least one of the one or more receivers by means of the second bus interfaceIn case that it is detected that the second transceiver has received the first message, the process for example returns to 501 and the first transceiver transmits a next (first) message. For example, only if a message sent by the first transceiver is not received by the second transceiver, the second transceiver transmits one or more second messages in addition the receiver.

It should be noted that embodiments described in context of the computer network 400 are analogously valid for the method illustrated in FIG. 5 and vice versa.

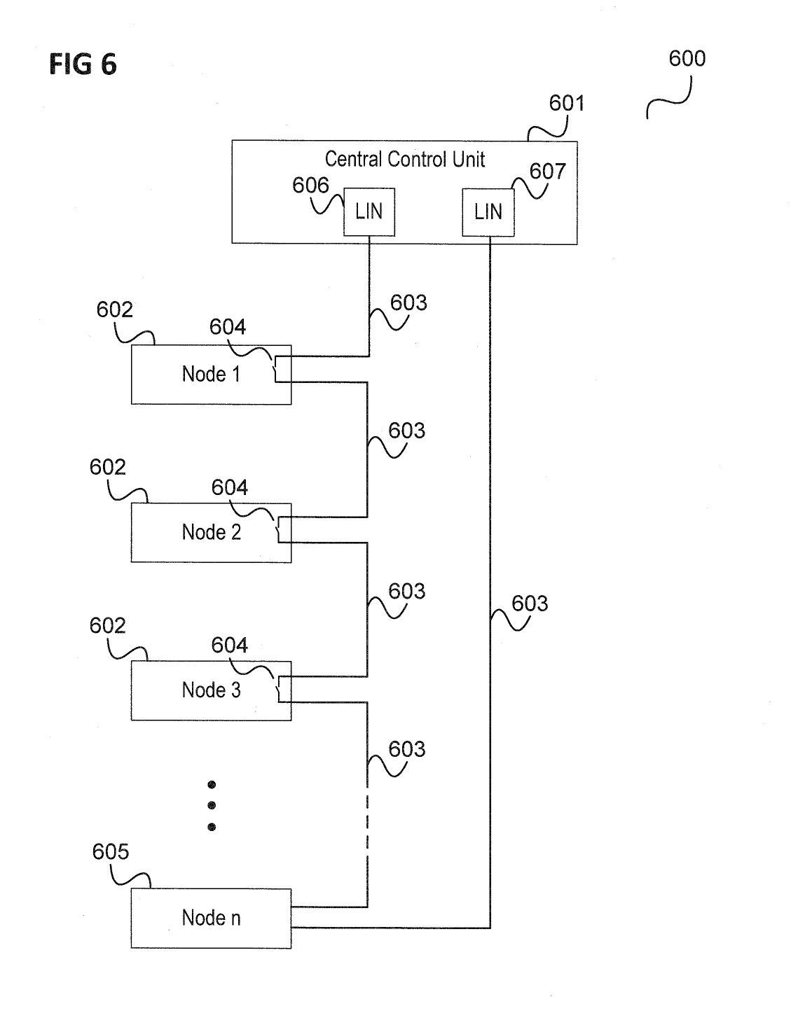

The case of the bus being a LIN bus is illustrated in FIG. 6.

FIG. 6 shows a communication network 600.

Similarly to the communication network 200, the communication network 600 includes a central controller 601 and a plurality of nodes 602, 605 connected by a bus 603 wherein each intermediate node 602 has a switch 604 for interrupting the bus 603 at the respective node 602.

The central controller 601 includes a first LIN transceiver 606 via which it acts as master for the bus 603, similarly to the LIN transceiver 206, and a second LIN transceiver 607 which form the endpoints of the bus 603. Alternatively, their (bus) interfaces to the bus may be seen as forming the endpoints of the bus. The second LIN transceiver 607 acts as a slave for the bus 603. In other words, compared to the communication network 200, the bus 603 is connected back from the last node in line 605 to the central controller 601, namely to the second LIN transceiver 607.

When all switches 604 are correctly closed (e.g. after the auto-addressing method has been carried out) the central controller 601 can communicate with itself by sending messages from the first LIN transceiver 606 via the bus 604 to the second LIN transceiver (failure LIN transceiver) 607. In this way, the central controller 601 can check whether the bus is interrupted at any of the nodes 602. When a node 602 fails (e.g. its switch 604 does not close or it interrupts the bus 603 in some other way due to its fail) the central controller 601 may detect this since a message sent by the first transceiver 601 cannot be received by the second transceiver 602 and may use the second transceiver 602 itself as master for the bus for serving the nodes 602 which are disconnected from the first transceiver 601 due to the fail. For example, in case the bus is interrupted at the second node 602 in the series of nodes 602, e.g. an interruption between the LIN transceiver 301 and the bus connection 304 to the subsequent node 602, 605, e.g. due to a failure of the switch 305, the first transceiver 606 acts as master for the first node 602 and the second node 602 and the second transceiver is switched to master and acts as master (e.g. continues the communication) with the third to nth slave 602, 605 in the series of slaves 602. For data to be sent to a slave 602, 605, the controller 601 may for example supply the data to the transceiver 606, 607 serving the slave 602, 605, i.e. acting as master for the slave 602, 605.

For detection whether a message sent by the first transceiver 606 has been received by the second transceiver 607, the second transceiver 607 may for example inform a detector of the controller 601 about all messages received and the detector compares these with messages sent by the first transceiver 606. Alternatively, the second transceiver 607 is informed about messages sent by the first transceiver 606 and indicates that a message has not been received when a message sent by the first transceiver 606 has not arrived at the second transceiver 607.

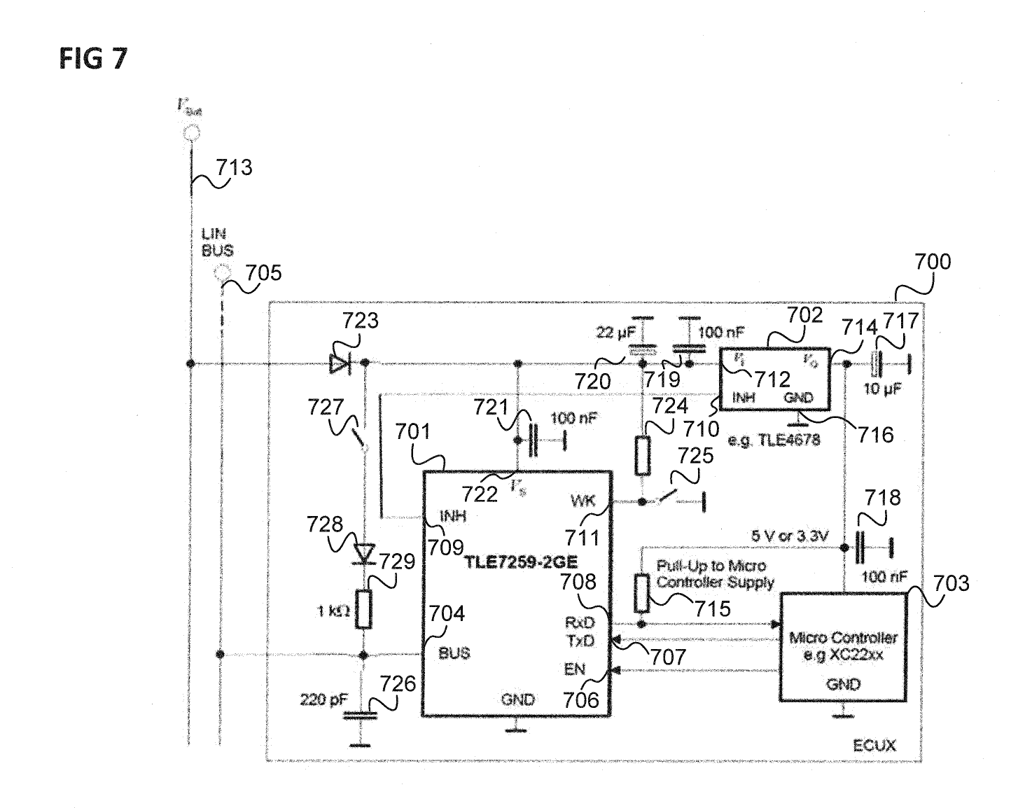

An example for the second transceiver 607 is given in FIG. 7.

FIG. 7 shows LIN transceiver module 700.

The LIN transceiver module 700 may be configured as a bus master as well as a bus slave.

The transceiver module 700 includes a LIN transceiver 701, a voltage controller 702 and a microcontroller 703.

The LIN transceiver 701 includes a bus terminal 704 connected to a LIN bus 705, an enable input 706 via which the microcontroller 703 may activate the UN transceiver 701, a data input 707 for receiving data to be sent by the LIN transceiver 701 via the bus 705 from the microcontroller 703, a data output 708 for providing data received by the LIN transceiver 701 via the bus 705 to the microcontroller 703, an inhibit terminal 709 connected to an inhibit terminal 710 of the voltage controller 702 to sent a request for power to the voltage controller 702 and a wake signal input 711 for receiving a signal to wake up the transceiver 701 when in sleep mode.

The voltage controller 702 has a voltage input 712 connected to a power supply line 713 (e.g. connected to a vehicle battery) via a diode 723, a power output 714 for supplying the microcontroller 703 connected to the microcontroller 703 and connected to the data output 708 of the LIN transceiver 701 via a first resistor 715 and a ground terminal 716. The power output is further connected via a first capacitor 717 and a second capacitor 718 to ground. The voltage input 712 is connected via a third capacitor 719, a fourth capacitor 720 and a fifth capacitor 721 to ground.

The LIN transceiver 701 is connected to the power supply line 705 via the diode 723. The wake signal input 711 is connected to the voltage input 712 via a second resistor 724 and via a first switch 725 to ground. The first switch 725 may be used to wake up the LIN transceiver 701. The bus terminal 704 is connected via a sixth capacitor 726 to ground.

A second switch 727 is connected between the voltage input 712 and, via a second diode 728 and a third resistor 729, the bus terminal 704. When the second switch 727 is open, the LIN transceiver module 700 acts as a slave. When the second switch 727 is closed (e.g. in response to a control signal by the controller 601 due to the fact that an interruption of the bus 603 at one of the slaves 602 has been detected) the LIN transceiver module 700 acts as a master.

According to one embodiment, instead of providing a second LIN transceiver 607 and switching it to act as master in case of an interruption of the bus 603, the first LIN transceiver 606 may be connected to both endpoints of the bus 603 (e.g. by closing a corresponding switch) in case of an interruption of the bus 603 such that messages provided by the first LIN transceiver 606 are supplied to the bus 603 from both ends and can reach slaves even in case of an interruption. In this embodiment, an interruption of the bus 603 may be detected by the first transceiver by detecting whether reception acknowledgments are received from all slaves 602 for a message sent by the first transceiver.

While specific aspects have been described, it should be understood by those skilled in the art that various changes in form and detail may be made therein without departing from the spirit and scope of the aspects of this disclosure as defined by the appended claims. The scope is thus indicated by the appended claims and all changes which come within the meaning and range of equivalency of the claims are therefore intended to be embraced.

What is claimed is:

1. A communication network comprising
a first bus interface;
a second bus interface;
a bus which connects the first bus interface and the second bus interface;
one or more receivers connected to the bus;
a detector configured to detect whether a first message transmitted via the bus by the first bus interface has reached the one or more receivers; and
a controller configured to, if the first message has not reached the one or more receivers, control the second bus interface to transmit at least one second message to at least one of the one or more receivers via the bus.

2. The communication network according to claim 1, wherein the detector is configured to detect whether the first message has reached the one or more receivers by detecting whether the first message has been received by the second bus interface.

3. The communication network according to claim 1, wherein the detector is configured to detect whether the first message has reached the one or more receivers by detecting whether the one or more receivers have received the first message.

4. The communication network according to claim 1, wherein the detector is configured to detect whether the first message has reached the one or more receivers by detecting whether the one or more receivers have acknowledged reception of the first message.

5. The communication network according to claim 4, wherein the detector is configured to detect whether the one or more receivers have acknowledged reception of the first message by counting the number of acknowledgements of reception of the first message and comparing the number with the number of receivers.

6. The communication network according to claim 1, wherein the one or more receivers are connected to the bus at one or more connection points of the bus that lie between the connection points of the first bus interface and the second bus interface to the bus.

7. The communication network according to claim 1, further comprising a first transceiver coupled the first bus interface configured to supply the first message to the first bus interface.

8. The communication network according to claim 7, wherein the first transceiver is coupled to the detector and is configured to inform the detector about the transmission of the first message.

9. The communication network according to claim 7, wherein the first transceiver is configured to provide the second message and is coupled to the second bus interface by means of a switch and the controller is configured to control the switch such that the second message is supplied to the second bus interface if the first message has not reached the one or more receivers.

10. The communication network according to claim 7, wherein the first transceiver acts as a master of the bus.

11. The communication network according to claim 1, further comprising a second transceiver coupled to the second bus interface wherein the controller is configured to, if the first message has not reached the one or more receivers, control the second bus interface to transmit the at least one second message to at least one of the one or more receivers via the bus by controlling the second receiver to supply the second message to the second bus interface.

12. The communication network according to claim 1, further comprising a second transceiver coupled with the second bus interface wherein the second transceiver is coupled to the detector and is configured to inform the detector about the reception of the first message and wherein the detector is configured to detect whether the first message has reached the one or more receivers by detecting whether the second transceiver has received the first message.

13. The communication network according to claim 12, wherein the controller is configured to, if the second transceiver has not received the first message, switch the second transceiver from a slave mode in which it acts as a slave of the bus to a master mode in which it acts as a master of the bus.

14. The communication network according to claim 13, wherein the second transceiver, when in master mode, is configured to control bus usage by the one or more receivers.

15. The communication network according to claim 1, wherein the first message is addressed to the at least one of the one or more receivers.

16. The communication network according to claim 1, wherein the second message is addressed to the at least one of the one or more receivers.

17. The communication network according to claim 1, wherein the second message is an inquiry message.

18. The communication network according to claim 1, wherein the first message is a test message for testing whether the second bus interface can be reached by the first bus interface via the bus.

19. The communication network according to claim 1, wherein the second message is an address allocation message for assigning an address to the at least one of the one or more receivers.

20. The communication network according to claim 1, wherein the second message is a communication control message for controlling usage of the bus by the at least one of the one or more receivers.

21. The communication network according to claim 1, wherein the second message is a data request message requesting data from the at least one of the one or more receivers.

22. The communication network according to claim 1, wherein bus is a Local Interconnect Network bus.

23. The communication network according to claim 1, wherein the one or more receivers act as slaves of the bus.

24. The communication network according to claim 1, further comprising a control device configured to supply the first message to the first bus interface and, if the first message has not reached the one or more receivers to supply the second message to the second bus interface.

25. The communication network according to claim 24, wherein the control device is a central controller of a vehicle and the one or more receivers are control devices configured to control vehicle components.

26. The communication network according to claim 1, further comprising at least one switch for interrupting the bus.

27. The communication network according to claim 26, comprising a plurality of receivers, wherein the at least one switch is arranged to interrupt the bus between two receivers of the plurality of receivers.

28. The communication network according to claim 1, wherein the first bus interface and the second bus interface form the endpoints of the bus.

29. A method for communicating in a communication network comprising:
transmitting a first message via a bus connecting a first bus interface and a second bus interface by means of the first bus interface;
detecting whether the first message has been received by one or more receivers connected to the bus; and
transmitting, if the first message has not reached the one or more receivers, a second message via the bus to at least one of the one or more receivers by means of the second bus interface.
